(19) United States
(12) Patent Application Publication
(10) Pub. No.: US 2021/0262822 A1
(43) Pub. Date: Aug. 26, 2021

(54) INFORMATION PROVIDING SYSTEM

(71) Applicant: HONDA MOTOR CO., LTD., TOKYO (JP)

(72) Inventors: Tomoaki HAGIHARA, WAKO-SHI (JP); Satoshi KAMATANI, WAKO-SHI (JP); Mitsuki KIMURA, WAKO-SHI (JP); Yuiko KUMAGAI, WAKO-SHI (JP); Kazuya WATANABE, WAKO-SHI (JP)

(21) Appl. No.: 17/182,815

(22) Filed: Feb. 23, 2021

(30) Foreign Application Priority Data
Feb. 26, 2020 (JP) 2020-030267

(51) Int. Cl. G01C 21/36; G06F 16/9537; G06F 16/9536; G01C 21/34

(52) U.S. Cl. CPC G01C 21/3679; G01C 21/3484; G06F 16/9536; G06F 16/9537

(57) ABSTRACT

A server is equipped with a POI information recording unit in which identification information of POI is recorded in association with referral information of the POI, a referral text creation unit which creates referral text concerning the POI using the referral information associated with the POI, and a user condition acquisition unit which acquires user conditions. The referral text creation unit creates the referral text of the POI by determining, based on the acquired user condition, which referral information among pieces of the referral information is to be used.

### CROSS-REFERENCE TO RELATED APPLICATION

This application is based upon and claims the benefit of priority from Japanese Patent Application No. 2020-030267 filed on Feb. 26, 2020, the contents of which are incorporated herein by reference.

### BACKGROUND OF THE INVENTION

### Field of the Invention

The present invention relates to an information providing system that provides information about points of interest (hereinafter referred to as POI or spots) to a user in accordance with a position of the user.

### Description of the Related Art

For example, in Japanese Laid-Open Patent Publication No. 10-013961 (hereinafter referred to as JPH10-013961A), a mobile communication system is disclosed in which, by a mobile terminal transmitting information of its own position to an information center, the mobile terminal is capable of using facility information or services of facilities related to position information which is stored in a storage unit of the information center (see paragraphs [0019] and [0119] of JPH10-013961A).

### SUMMARY OF THE INVENTION

The mobile communication system disclosed in JPH10-013961A provides the facility information and the like in accordance with the position of the user of the mobile terminal.

However, a problem arises in that it is not possible to provide appropriate referral information of POI tailored to a condition of the user, such as being in the course of traveling or the like.

The present invention has been devised taking into consideration the aforementioned problem, and has the object of providing an information providing system, which is capable of supplying to a user appropriate referral information of points of interest (POI) tailored to a condition of the user.

One aspect of the present invention is characterized by an information providing system comprising a points of interest (POI) information recording unit configured to record identification information of POI in association with referral information of the POI, and a referral text creation unit configured to create referral text concerning the POI by using the referral information associated with the POI, the information providing system further comprising a user condition acquisition unit configured to acquire user conditions, wherein the referral text creation unit creates the referral text of the POI by determining, based on the acquired user condition, which referral information among pieces of the referral information is to be used.

According to the present invention, based on the user condition acquired by the user condition acquisition unit, the referral text of the POI is created by determining which referral information among the pieces of the referral information is to be used, and therefore, appropriate POI referral information can be provided which is tailored to the user condition.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing the configuration of a system including a server which serves as an information providing system according to an embodiment of the present invention;

FIG. 2 is a table in which there is shown an example of the content recorded in a POI information recording unit;

FIG. 3 is a table in which there is shown an example of recorded content in a user condition/type recording unit;

FIG. 4 is a flowchart provided to describe operations of the system including the server serving as the information providing system according to the embodiment; and

FIG. 5 is a detailed flowchart of a user condition specifying process from within the flowchart of FIG. 4.

### DETAILED DESCRIPTION OF THE PREFERRED EMBODIMENTS

An embodiment of an information providing system according to the present invention will be presented and described in detail below with reference to the accompanying drawings.

### EMBODIMENT

### [Configuration]

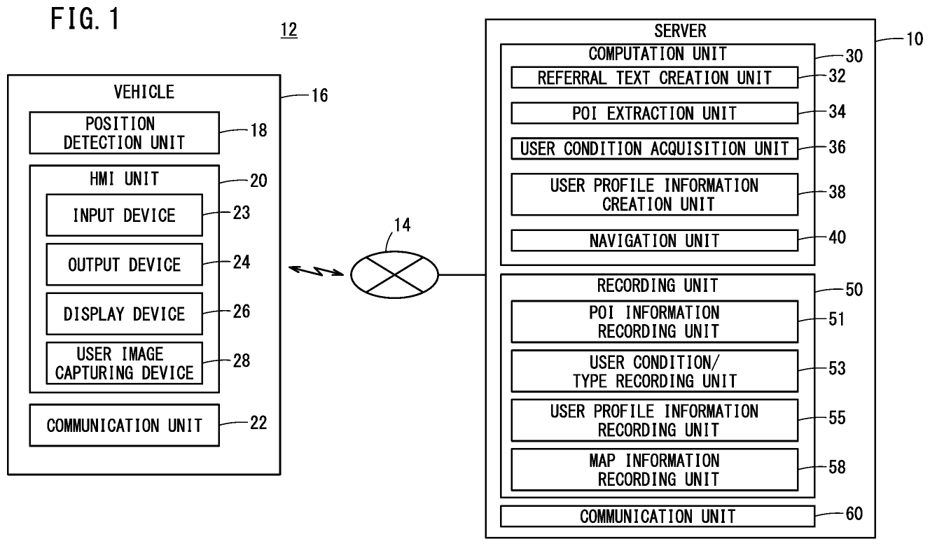

FIG. 1 is a diagram showing the configuration of a system 12 including a server 10 serving as an information providing system according to the embodiment.

In addition to the server 10, the system 12 is equipped with a vehicle 16 which is used by a user and which carries out communications via a network 14 such as a public line or the like.

The vehicle 16 includes a position detection unit 18, a human-machine interface unit (HMI unit) 20 that governs or controls an interface with the user, and a communication unit 22.

The HMI unit 20 includes an input device (a voice input device or a manual input device) 23 such as a microphone or a touch panel or the like, an output device 24 such as a speaker, a display device 26 that can serve in a dual manner as an input/output device, and a user image capturing device 28 which is made up of cameras.

The user image capturing device 28, for example, is a plurality of user monitor cameras which are mounted in the vehicle compartment interior, and which constantly capture images of all of the occupants in the vehicle by the plurality of cameras, including the head (face) of a user such as the driver. The user image capturing device 28 creates user captured image information of all of the vehicle occupants.

The position detection unit 18, for example, is a navigation device, and detects the position of the vehicle 16. As is well known, on the basis of recorded map information, the navigation device searches by way of a route searching unit for a recommended route to a destination set by the HMI unit 20 in accordance with an input from the user, and guides the user to the destination by guiding the vehicle 16 to the destination according to the recommended route that was searched for.

The communication unit 22 transmits to the server 10 via the network 14 the position information of the vehicle 16 that is detected by the position detection unit 18, the input information obtained by the input device 23 of the HMI unit 20, and the user captured image information obtained by the user image capturing device 28. Further, the communication unit 22 receives the information transmitted from the server 10, for example, route information to a specified POI, and outputs the information to the output device 24 or on the display device 26 of the HMI unit 20.

Moreover, according to the present embodiment, a navigation unit 40 of the server 10 obtains, through the communication unit 22, the network 14, and a communication unit 60, the destination (including the specified POI) that was set by the HMI unit 20 in accordance with the input from the user, searches for the recommended route to the destination based on the map information recorded in a map information recording unit 58, and sets the set route, which is the result of the route search, in the position detection unit 18 of the vehicle 16 through the communication unit 60, the network 14, and the communication unit 22. In this case, the vehicle 16 in which the user is riding is guided in accordance with the set route that is the result of the route search, and the user can be guided to the destination, or stated otherwise, route guidance can be performed. The map and the set route are displayed on the display device 26.

The server 10 is a computer, and includes a computation unit 30, a recording unit 50, and the communication unit 60. The computation unit 30 is constituted by a processor equipped with, for example, a CPU or the like. The computation unit 30 realizes various functions by executing programs recorded in the recording unit 50. In this instance, the computation unit 30 functions as a referral text creation unit 32, a POI extraction unit 34, a user condition acquisition unit 36, a user profile information creation unit 38, and the navigation unit 40.

In addition to the programs, the recording unit 50 includes a POI information recording unit 51, a user condition/type recording unit 53, a user profile information recording unit 55, and the map information recording unit 58.

The POI information recording unit 51 records the POI identification information and the POI referral information in association with each other.

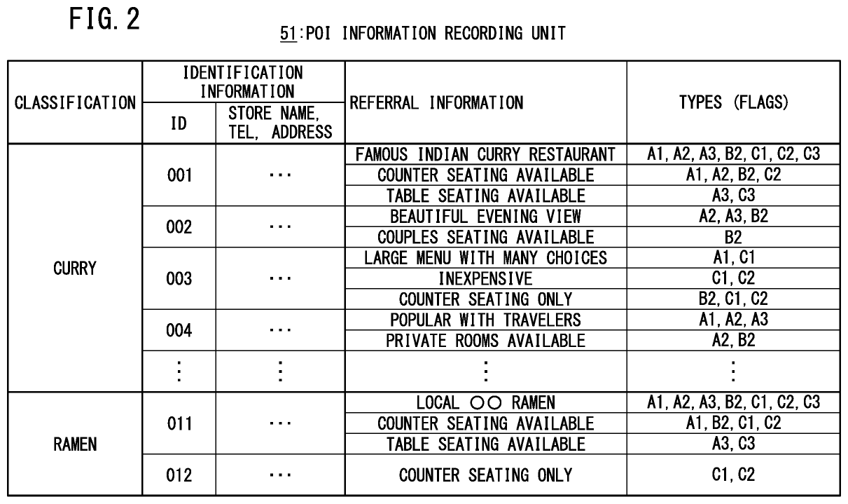

FIG. 2 is a table in which there is shown an example of the content recorded in the POI information recording unit 51.

The POI information recording unit 51 includes as items thereof specific terms {classifications (curry, ramen, etc.)}, identification information {an ID, a store name, a telephone number (TEL), an address}, referral information, and types (flags).

The user condition/type recording unit 53 records the condition (state) of the user acquired by the user condition acquisition unit 36, and a type (flag) associated with such a state.

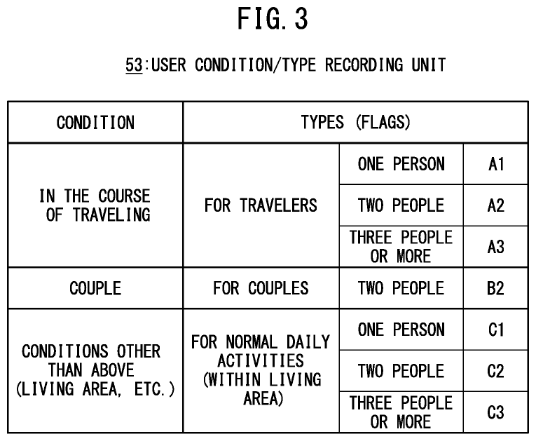

FIG. 3 is a table in which there is shown an example of recorded content in the user condition/type recording unit 53.

The user condition/type recording unit 53 associates with each other a condition {in the course of traveling, a couple, and conditions other than the foregoing (a living area, etc.)} and a type {for travelers (flag A), for couples (flag B), and for normal daily activities (within the living area) (flag C)}.

As for the types (flags), in addition to the target such as “for travelers”, the number of vehicle occupants (one person, two people, three people or more) is designated, and flags A1 to A3, B2, and C1 to C3 are associated therewith depending on the target and the number of vehicle occupants.

The types (flags) recorded in the user condition/type recording unit 53 of FIG. 3 are recorded in advance in association with respective pieces of referral information in a type (flag) column of the POI information recording unit 51 shown in FIG. 2.

The user condition acquisition unit 36 identifies the users whose images are captured by the user image capturing device 28, and more specifically, the user seated in the driver's seat and users seated in the remaining seats, and based on behaviors (behavior history) of the respective identified users of the vehicle 16, extracts user profiles to create user profile (user-specific profile) information, and records the user profile information in the user profile information recording unit 55.

In the created user profiles, there are included, for example, for each of the users, cumulative numbers corresponding to a usage record for each type (flag) of the specific terms (classifications) of the POI (see FIG. 2) which are set by the user.

The map information recording unit 58 includes route calculation information used by the navigation unit 40 to calculate the set route (recommended route), and route guidance information, road information representing the shapes of roads, and furthermore, background information representing map shapes other than roads, such as coastlines, rivers, railways, and buildings, etc., along with the POI information and the like, which are used for guiding the user's own vehicle 16 to a destination according to the recommended route including the names of intersections, road names, and the like.

The referral text creation unit 32 creates referral text concerning specific POI.

The POI extraction unit 34 extracts from the POI information recording unit 51 at least one of the POI to be recommended to the user, in accordance with the specific term (classification) that was set based on the input from the user of the vehicle 16.

### [Operations]

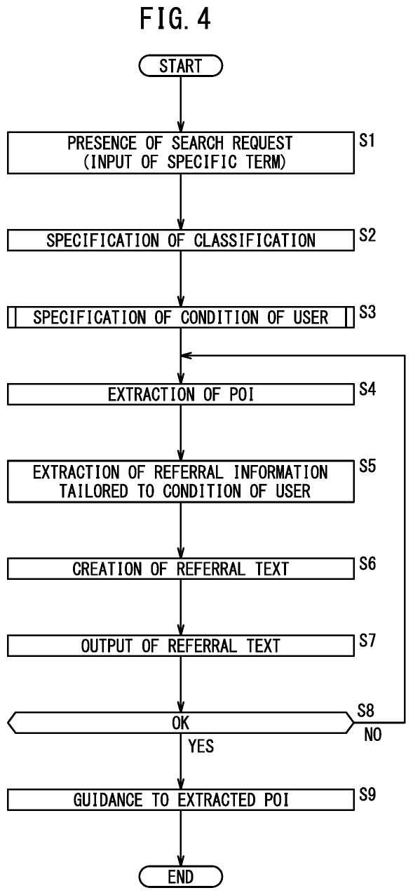

Next, on the basis of the flowchart shown in FIG. 4, a description will be given in detail concerning operations of the system 12 including the server 10 in the form of the information providing system according to the embodiment, which is configured basically in the manner described above. Unless otherwise specified, it will be assumed that the computation unit 30 of the server 10 executes the processes according to the flowchart. However, since it is complicated to refer to this feature each time that it happens, such a feature will be referred to only as necessary.

In step S1, the POI extraction unit 34 performs a specific term specifying process in step S2, which is triggered by the fact that a user search request that was input by the input device 23 of the vehicle 16 (in this instance, a search request made by voice, saying “search for a curry restaurant”) is received by the communication unit 60 via the communication unit 22.

In step S2, based on the voice input of “search for a curry restaurant,” the POI extraction unit 34 specifies the specific term (classification) as “curry” by referring to the specific term (classification) in the POI information recording unit 51.

Next, in step S3, the user condition acquisition unit 36 specifies the conditions of the users from images (facial images and the number of vehicle occupants) captured by the user image capturing device 28.

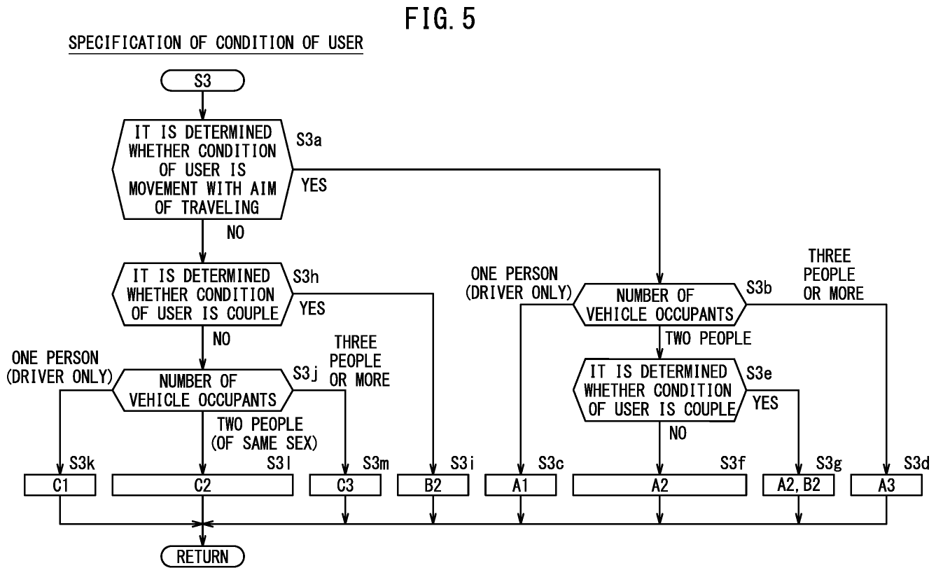

FIG. 5 is a detailed flowchart of a user condition specifying process of step S3.

In step S3a, whether or not the condition of the user is movement with the aim of traveling is determined depending on whether or not a navigation designation is at a position separated away from the living area of the house (house of the driver). The living area is set to a region that includes, for example, a supermarket, a restaurant, an office of the user, or the like, of a local area frequently used within a range of a predetermined number of kilometers from the house.

In the case that the movement is with the aim of traveling (step S3a: YES), then in step S3b, whether the number of vehicle occupants is one person (only the driver) or three people or more is determined, and in step S3c and S3d, with reference to the user condition/type recording unit 53, the types (flags) are determined to be A1 (in the course of traveling—for travelers—one person) and A3 (in the course of traveling—for travelers—three people or more) depending on the number of vehicle occupants.

Further, in step S3b, in the case that the number of vehicle occupants is two people, then in step S3e, it is determined whether or not the condition of the users is a couple (a combination of two people who are a man and a woman, for example), and in the case of being a couple (step S3e: YES), then in step S3g, with reference to the user condition/type recording unit 53, the types (flags) are determined to be A2 (in the course of traveling—for travelers—two people) and B2 (a couple—for couples—two people). In the case of not being a couple (step S3e: NO), then in step S3f, with reference to the user condition/type recording unit 53, the type (flag) is determined to be A2 (in the course of traveling—for travelers—two people).

On the other hand, in the determination of step S3a, in the case that the condition of the user is not the movement with the aim of traveling (step S3a: NO), then in step S3h, a determination is made as to whether or not the condition of the user is a couple.

In the case of being a couple (step S3h: YES), then in step S3i, with reference to the user condition/type recording unit 53, the type (flag) is determined to be B2 (couple—for couples—two people).

In the case of not being a couple (step S3h: NO), and more specifically, in the case of not being in the course of traveling (step S3a: NO) and not being a couple, with reference to the user condition/type recording unit 53, the condition of the user is determined to be “within the living area,” and in step S3j, whether the number of vehicle occupants is one (driver only), two people (of the same sex), or three people or more is determined, and in steps S3k, S3l, and S3m, with reference to the user condition/type recording unit 53, the types (flags) are determined to be C1 (within the living area—for normal daily activities (within the living area)—one person), C2 (within the living area —for normal daily activities (within the living area)—two people), and C3 (within the living area—for normal daily activities (within the living area)—three people or more) depending on the number of vehicle occupants.

In step S4, the POI extraction unit 34 extracts the ID of at least one of the POI from the POI information recording unit 51 in accordance with the specific term “curry.” For example, the POI extraction unit 34 extracts the ID of the POI whose distance from the current location of the user lies within a predetermined distance of X km. In this instance, it is assumed that ID 004 is extracted. Moreover, the POI extraction unit 34 may extract the ID of the POI based on the condition of the user.

In step S5 (see FIG. 4), the referral text creation unit 32 extracts, from the POI information recording unit 51 (see FIG. 2), the referral information tailored to the condition of the user (associated with the condition of the user) determined in step S3, from among pieces of the referral information concerning the POI extracted by the POI extraction unit 34.

In this case, for example, when the condition of the users is determined to be of type (flag) A3 (in the course of traveling—for travelers—three people or more), the referral text creation unit 32 extracts, from the POI information recording unit 51 (see FIG. 2), the text “popular with travelers” with which the type A3 (in the course of traveling—for travelers—three people or more) is associated, from among the pieces of the referral information concerning the POI (ID 004) extracted by the POI extraction unit 34.

Next, in step S6, using the referral information extracted in step S5, the referral text creation unit 32 creates the referral text concerning the POI (ID 004) extracted by the POI extraction unit 34.

In this case, for the referral text, the text “a curry restaurant popular with travelers is located nearby” is created.

Alternatively, from an address within the identification information of the extracted POI and the current position of the vehicle 16, for example, the text “a curry restaurant popular with travelers is located ◯◯ km up ahead along the road” may be created.

Next, in step S7, data of the information (image information and voice information), which includes the referral text created by the referral text creation unit 32, is transmitted to the output device 24 and the display device 26 via the communication unit 60, the network 14, and the communication unit 22.

Consequently, in step S7, the position of the curry restaurant of ID 004 is displayed on the map of the display device 26, together with a voice output being provided from the output device 24 including the statement “a curry restaurant popular with travelers is located ◯◯ km up ahead along the road.”

In step S8, a determination is made as to whether or not to select the POI that was introduced (OK), and in the case that indication of an intention by the user to reject (i.e., a voice input such as “is there any other location?”) is confirmed, the process returns to step S4, and the POI extraction unit 34 extracts the POI, in this instance, the POI of ID 001, under conditions that differ from the previous ones (for example, the distance from the current location of the user is a predetermined distance Y (>X) km).

Next, in step S5, from among the pieces of the referral information of the POI of ID 001, the text “famous Indian curry restaurant,” which is referral information in accordance with the condition of the user {A3 (in the course of traveling—for travelers—three people or more)} determined in step S3, is extracted. Next, in step S6, using the extracted referral information (in this instance, “famous Indian curry restaurant”), the referral text creation unit 32 creates the referral text of the POI (ID 001) extracted by the POI extraction unit 34.

In this case, for the referral text, the text “a famous Indian curry restaurant is located nearby” is created. Alternatively, from an address within the identification information of the extracted POI and the current position of the vehicle 16, for example, the text “a famous Indian curry restaurant is located ◯◯ km up ahead along the road” is created.

Next, in step S7, data of the information (image information and voice information), which includes the referral text created by the referral text creation unit 32, is transmitted to the output device 24 and the display device 26 via the communication unit 60, the network 14, and the communication unit 22.

Consequently, in step S8, the position of the curry restaurant of ID 001 is displayed on the map of the display device 26, together with a voice output being provided from the output device 24 including the statement “a famous Indian curry restaurant is located ◯◯ km up ahead along the road.”

In the case that an OK input is detected in the determination of step S8 (step S8: YES), the referral text creation unit 32 uses the navigation unit 40 in step S9, whereby route guidance to the extracted POI of ID 004 or ID 001 is carried out (step S8: OK).

Moreover, in step S8, in the case that an input of NG information (information indicating that referral POI are not selected) from the user such as a question “is there any other location?” is detected, and further, in the case that, from among the POI extracted in the aforementioned step S4, there are POI that have not been output together with the referral text from the output device 24 or the display device 26, then regarding the POI that have not been output, the extraction of the referral information, and the creation and the output of the referral text in the aforementioned steps S5, S6, and S7 may be carried out.

[Inventions that can be Grasped from the Embodiment]

A description will be given below concerning the inventions capable of being grasped from the above-described embodiment. Although in order to facilitate understanding, the reference numerals used in the embodiment are applied to the constituent elements, the constituent elements are not limited to those to which such reference numerals have been applied.

The information providing system (server 10) according to the present invention is characterized by an information providing system (server 10) comprising the points of interest (POI) information recording unit 51 in which the identification information of POI is recorded in association with the referral information of the POI, and the referral text creation unit 32 which creates the referral text concerning the POI by using the referral information associated with the POI, the information providing system further comprising the user condition acquisition unit 36 that acquires user conditions, wherein the referral text creation unit 32 creates the referral text of the POI by determining, based on the acquired user condition, which referral information among pieces of the referral information is to be used.

According to the above configuration, the referral text of the POI is created by determining which referral information among the pieces of the referral information is to be used based on the user condition acquired by the user condition acquisition unit 36, and therefore, appropriate POI referral information can be provided which is tailored to the user condition.

In this instance, the user condition/type recording unit 53 may preferably be provided in which types of the referral information to be prioritized are assigned to each of the user conditions.

In accordance with this feature, it is possible to accurately select or determine the user condition for which the referral information is to be provided.

Further, types associated with the user conditions are preferably recorded in the POI information recording unit 51 for each of the pieces of the referral information.

In accordance with this feature, by referring to the types (flags) associated with the user conditions, it is possible to extract accurate POI including referral information tailored to the user condition, as well as referral information concerning the POI.

Further still, in the case that the acquired user condition is a condition with the aim of making a predetermined movement, the referral text creation unit 32 may create the referral text of the POI using the referral information corresponding to the type (flag) preferentially associated with the condition with the aim of making the predetermined movement in the user condition/type recording unit 53.

In accordance with this feature, in the case that the user condition is the condition with the aim of making a predetermined movement, the referral text of the POI is created based on the user condition, and therefore, it is possible to provide appropriate POI referral information tailored to the user condition with the aim of making the predetermined movement.

In this case, if the condition with the aim of making the predetermined movement includes a condition of being in the course of traveling, it is possible for appropriate POI referral information to be provided which is tailored to travelers.

Moreover, in the case that the acquired user condition is a condition of moving with a plurality of people, the referral text creation unit 32 may create the referral text of the POI using the referral information corresponding to the type preferentially associated with the condition of moving with the plurality of people in the user condition/type recording unit 53.

In accordance with this feature, it is possible to provide appropriate POI referral information tailored to the user condition of moving with a plurality of people.

The present invention is not limited to the embodiment described above, and it is a matter of course that various modified or additional configurations could be adopted therein based on the disclosed content of the present specification. For example, in the above-described embodiment, the information providing system is provided in the form of the server 10; however, the information providing system may also be provided in the form of the vehicle 16, by the vehicle 16 being allowed to possess the computation unit 30 and the recording unit 50 shown in FIG. 1. The information providing system may be constituted by the server 10 and the vehicle 16. The vehicle 16 may be a passenger vehicle such as a four-wheeled vehicle, a truck, a two-wheeled vehicle, or the like. Further, the information providing system may be a mobile terminal such as a smartphone that is carried by the user.

What is claimed is:

1. An information providing system comprising a points of interest (POI) information recording unit configured to record identification information of POI in association with referral information of the POI, and a referral text creation unit configured to create referral text concerning the POI by using the referral information associated with the POI, the information providing system further comprising
a user condition acquisition unit configured to acquire user conditions,
wherein the referral text creation unit creates the referral text of the POI by determining, based on the acquired user condition, which referral information among pieces of the referral information is to be used.

2. The information providing system according to claim 1, further comprising a user condition/type recording unit in which types of the referral information to be prioritized are assigned to each of the user conditions.

3. The information providing system according to claim 1,
wherein types associated with the user conditions are recorded in the POI information recording unit for each of the pieces of the referral information.

4. The information providing system according to claim 2, wherein, in a case that the acquired user condition is a condition with an aim of making a predetermined movement, the referral text creation unit creates the referral text of the POI using the referral information corresponding to the type preferentially associated with the condition with the aim of making the predetermined movement in the user condition/type recording unit.

5. The information providing system according to claim 4, wherein the condition with the aim of making the predetermined movement includes a condition of being in a course of traveling.

6. The information providing system according to claim 3, wherein, in a case that the acquired user condition is a condition of moving with a plurality of people, the referral text creation unit creates the referral text of the POI using the referral information corresponding to the type preferentially associated with the condition of moving with the plurality of people in the user condition/type recording unit.
